(19) United States
(12) Patent Application Publication
(10) Pub. No.: US 2026/0182754 A1
(43) Pub. Date: Jul. 2, 2026

(54) MULTI-FUNCTIONAL COVERS FOR INFANT CARRIERS

(71) Applicant: Skip Hop, Inc., New York, NY (US)

(72) Inventors: Sierra Seip, Newburgh, NY (US); Luz Cabrera, Union, NJ (US)

(21) Appl. No.: 19/006,538

(22) Filed: Dec. 31, 2024

(51) Int. Cl. A47D 15/00; A47D 13/02

(52) U.S. Cl. CPC A47D 15/00; A47D 13/027

(57) ABSTRACT

A cover for an infant carrier according to one or more embodiments may include a body, a removable attachment, and/or a canopy. The body may include a storage pocket proximate a first end of the body and configured to receive any one or more of a removable attachment and a canopy, a top securing edge defining a top opening and configured to receive the removable attachment, and a bottom securing edge defining a bottom opening and configured to receive the infant carrier. The removable attachment may be configured to be removably secured to at least part of the top securing edge. The canopy may extend over a handle of the infant carrier and cover the top opening and may include a first securing edge affixed to the first end of the body and a second securing edge removably securable to the second end of the body.

### BACKGROUND

Infant carriers are devices designed to hold and transport young children in a comfortable and ergonomic way. Carriers may be used in conjunction with vehicles or strollers facilitating safe travel and easy transfer of the child.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An example embodiment includes an infant carrier cover including a body, a removable attachment, and a canopy. The body may be configured to cover at least part of the infant carrier. The body may include a top securing edge defining a top opening configured to receive a removable attachment and a bottom securing edge defining a bottom opening configured to receive the infant carrier. The removable attachment may include a fastener configured to affix the removable attachment to at least part of the top securing edge. The canopy may be configured to extend over an arm of the infant carrier and cover the top opening. The canopy may include a first securing edge affixed to a first end of the body, and a second securing edge removably securable to a second end of the body.

Another example embodiment includes an infant carrier cover including a body and a canopy. The body may be configured to cover at least part of the infant carrier. The body may include a top securing edge defining a top opening and a bottom securing edge defining a bottom opening configured to receive the infant carrier. The canopy may be configured to extend over an arm of the infant carrier and cover the top opening. The canopy may include a first securing edge affixed to a first end of the body and a second securing edge removably securable to a second end of the body.

Another example embodiment includes a cover for an infant carrier including a carrying handle and a base having a rear edge and a front edge. The cover may include a body, a removable attachment, and a canopy. The body may include a storage pocket proximate a first end of the body and configured to receive any one or more of a removable attachment and a canopy, a top securing edge defining a top opening and configured to receive the removable attachment, and a bottom securing edge defining a bottom opening and configured to receive the infant carrier. The removable attachment may be configured to be removably attached to at least part of the top securing edge. The canopy may be configured to extend over the carrying handle and cover the top opening. The canopy may include a first securing edge affixed to the first end of the body and a second securing edge removably securable to a second end of the body.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein, including in the various drawings and figures, are not to be interpreted as limiting, but merely as a representative basis for teaching one skilled in the art to variously employ one or more illustrative embodiments.

FIG. 1 is a side view of an exemplary cover system.

FIG. 2 is another side view of the cover system of FIG. 1.

FIG. 3 is a front view of the cover system of FIG. 1.

FIG. 4 is a rear view of the cover system of FIG. 1.

FIG. 5 is a top view of the cover system of FIG. 1.

FIG. 6 is a top view an exemplary attachment of the cover system of FIG. 1.

FIG. 7 is a top view of the attachment of FIG. 6 folded for storage.

FIG. 8 is a rear view of the attachment of FIG. 6 folded for storage.

FIG. 9 is a rear view of the attachment of FIG. 6 in storage.

FIG. 10 is a rear view of an exemplary canopy of the cover system of FIG. 1.

FIG. 11 is a side view of the canopy of FIG. 10.

FIG. 12 is a perspective view of the canopy of FIG. 10 draped over a handle of an infant carrier.

FIG. 13 is a front view of the canopy of FIG. 10 draped over the handle of the infant carrier.

FIG. 14 is a top view of the canopy of FIG. 10 draped over the handle of the infant carrier.

FIG. 15 is a side view of the canopy of FIG. 10 draped over the handle of the infant carrier.

FIG. 16 is another side view of the canopy of FIG. 10 draped over the handle of the infant carrier.

FIG. 17 is a rear view of the canopy of FIG. 10 draped over the handle of the infant carrier.

FIG. 18 is a rear view of the canopy of FIG. 10 draped over the handle of the infant carrier and the attachment folded for storage.

FIG. 19 is a rear view of the canopy of FIG. 10 draped over the handle of the infant carrier and the attachment in storage.

### DETAILED DESCRIPTION

Reference will now be made in detail to various embodiments, examples of which are illustrated in the accompanying drawings. While this disclosure includes certain embodiments, it will be understood the disclosure is not intended to limit the claims to these embodiments. On the contrary, the disclosure is intended to cover alternatives, modifications, and equivalents, which may be included within the spirit and scope of the claims. Furthermore, in this detailed description, numerous specific details are set forth in order to provide a thorough understanding. However, one of ordinary skill in the art will appreciate that the subject matter of the present disclosure may be practiced without these specific details. In other instances, well known methods, procedures, and components have not been described in detail as not to unnecessarily obscure aspects of the present disclosure.

Various embodiments of this disclosure include a cover for an infant carrier. The cover may be multi-functional, including one or more attachments that can be removably attached to the cover (e.g., a blanket or a sunshade) as well as an integrated canopy that can be draped over a carrying handle (e.g., in a vertical or near vertical position) of the carrier to create a barrier between the infant and the environment (e.g., sun, weather, insects, debris, etc.) while providing more interior space for the infant than may be provided by an attachment.

The cover may also be compatible with a variety of carriers. The cover may include a bottom securing edge defining a bottom opening configured to receive the carrier. The bottom securing edge may include an adjustable closure to enable the cover to fit around carriers of varying shapes and/or sizes.

The cover may also be removable and portable. The adjustable closure of the cover may also enable the cover to be removed from one carrier and placed on another carrier of a similar or different shape and/or size. The cover may be constructed from one or more flexible materials, enabling the cover to be easily compacted (e.g., folded, rolled, compressed, etc.) when not in use.

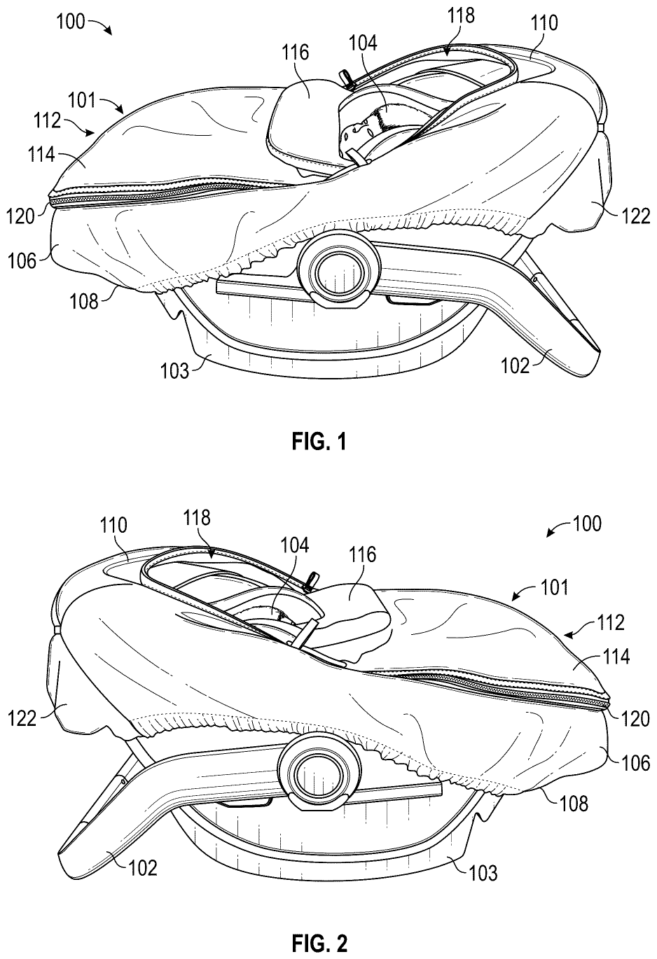

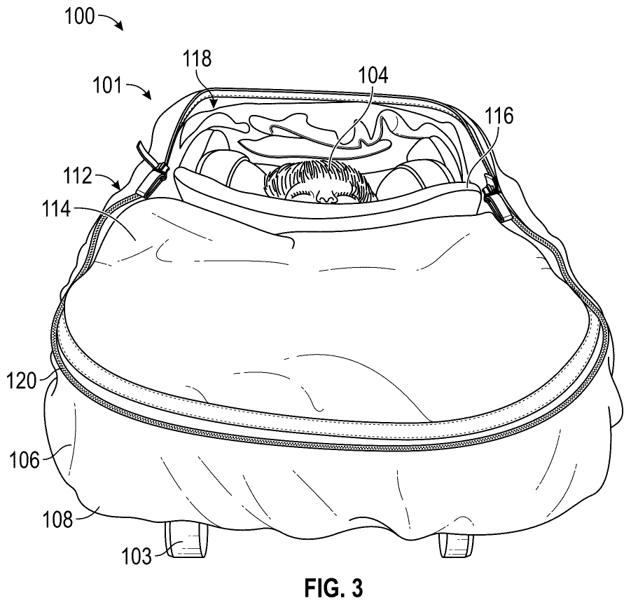

FIGS. 1-4 are various views of an exemplary cover system 100. The cover system 100 includes an infant carrier 103 and a cover 101. The carrier 103 (e.g., a car seat, child restraint system, bucket seat, etc.) may include a contoured plastic shell that forms the base of the carrier 103. The shell of the carrier 103 may be made (e.g., molded) from high-density, impact-resistant materials (e.g., high-density polyethylene), configured to withstand significant impact forces while cradling the infant 104 securely.

The carrier 103 may include a seat configured to support a natural posture of the infant 104, such as a reclined seat for younger children or a more upright seat for older children. The seat of the carrier 103 may include a layer of impact-absorbing material (e.g., expanded polystyrene) to absorb and dissipate collision forces. The seat of the carrier 103 may also include a layer of soft material (e.g., high-density polyurethane foam) for a stable and comfortable seating surface.

The carrier 103 may include a handle 102. The handle 102 may be part of an arched arm integrated into the carrier 103 via pivot joints or hinges located on either or both sides of the carrier 103, enabling the handle 102 to rotate around the carrier 103. The handle 102 may be rotated backward and/or downward into a stowage position (e.g., as shown in FIGS. 1-4). The handle 102 may also be rotated to extend vertically above the carrier 103 facilitating hand-carrying the carrier 103. The handle 102 in the upright position may act as a tension support for the canopy 124 fabric in some embodiments, creating a taut and stable shield over the carrier 103, as described in further detail below.

As described herein, the rear of the carrier 103 may refer to the end of the carrier 103 near the head of the infant 104, the front of the carrier 103 may refer to the end of the carrier 103 near the feet of the infant 104, the right side of the carrier 103 may refer to the side of the carrier 103 near the right side of the infant 104, and the left side of the carrier 103 may refer to the side of the carrier 103 near the left side of the infant 104.

The cover system 100 also includes a cover 101 for the infant carrier 103. The cover 101 includes a body 106 configured to cover at least part of the carrier 103. The body 106 may be made from fabric such as nylon (e.g., ripstop nylon) or polyester (e.g., tightly woven). The body 106 may be made from a single piece of material or multiple pieces of material, such as two pieces of material (e.g., top and bottom) with seams at the sides.

The body 106 may include a bottom securing edge 108 and a top securing edge 110 to hold the body 106 to the carrier 103. The bottom securing edge 108 may define a bottom opening configured to receive the carrier 103. The bottom securing edge 108 may include an adjustable closure configured to hold the body 106 to the carrier 103, such as elastic or a drawstring. In some embodiments, the bottom securing edge 108 may be formed from an elastic channel (e.g., 1″ wide continuous elastic channel) around the circumference of the bottom opening. To place the body 106 on the carrier 103, the bottom securing edge 108 may be opened (e.g., by stretching the elastic) to a size greater than the top of the carrier 103, placed over the top of the carrier 103, and secured (e.g., by releasing the elastic), tightening the bottom opening to a size less than the top of the carrier 103 so that the bottom securing edge 108 cannot slide off from the top of the carrier 103. In some embodiments, the bottom securing edge 108 may also or instead include one or more fasteners (e.g., snaps, hooks, zippers, drawstrings, straps, hook-and-loop fasteners) that engage with the carrier 103 (e.g., corresponding fasteners on the carrier 103) to secure the body 106 to the carrier 103.

The top securing edge 110 may define a top opening 118 to prevent the body 106 from obstructing the view of the infant 104 and provide access to the seat of the carrier 103. When the body 106 is placed over the carrier 103, the top securing edge 110 may prevent the carrier 103 from passing through the body 106 because the top opening 118 may be smaller than the top of the carrier 103. For example, the size of the top opening 118 causes some of the body 106 to extend over the carrier 103 (e.g., by 1-5″) preventing the carrier 103 from passing through the top opening 118. The top securing edge 110 may be configured to receive one or more removable attachments 112 and may include one or more fasteners 120 (e.g., zippers, buttons, or hook-and-loop) to secure the one or more removable attachments 112 to the body 106 over the infant 104. The one or more fasteners 120 may extend around some or all of the circumference of the top opening 118. For example, the fastener 120 shown in FIGS. 1-3 is a zipper that extends approximately half the length down the left side of the top opening 118 across a front side of the top opening 118 and approximately half the length up the right side of the top opening 118. This way, when the attachment 112 (e.g., blanket) is affixed to the top securing edge (e.g., via the zipper around part of the top opening 118) the front half of the carrier 103 covers the infant 104 below the head of the infant 104, leaving space above the head for the infant 104 to see outside the top opening 118. In some embodiments, the top securing edge 110 may include one or more fasteners (e.g., buttons or hook and loop) to secure the body 106 to the carrier 103 (e.g., via corresponding fasteners on the carrier 103).

The body 106 may include a storage pocket 122. The storage pocket 122 may be a slip pocket, zippered pocket, cargo pocket, or any other kind of pocket and may be made from cotton, polyester, nylon, mesh, or other suitable material. The storage pocket 122 may be located on the body 106 such that the storage pocket 122 is on or proximate to a side (e.g., rear or front) of the carrier 103 when the body 106 is placed on the carrier 103. The storage pocket 122 may include an opening 123 configured to receive one or more removable attachments 112 and/or the canopy 124. The opening 123 may include a fastener (e.g., zipper or hook and loop) so that the opening 123 may be closed to prevent the contents of the storage pocket 122 from falling out of the storage pocket 122.

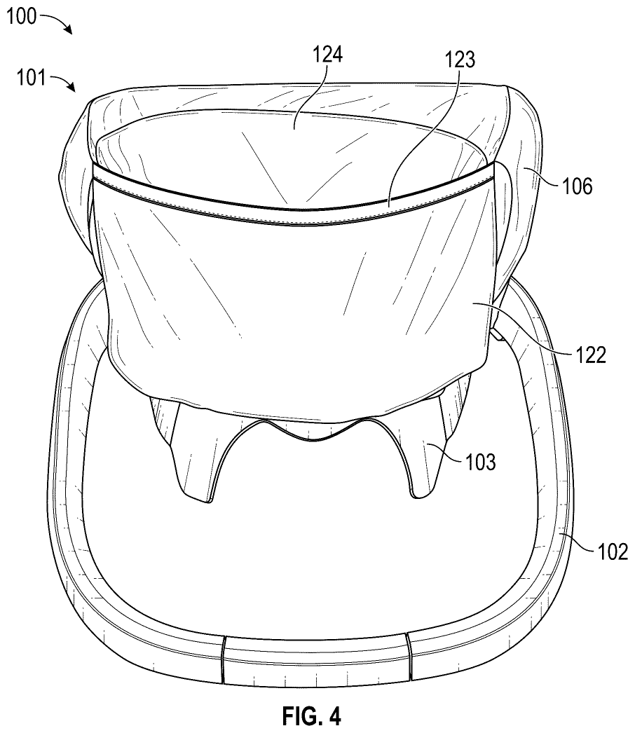

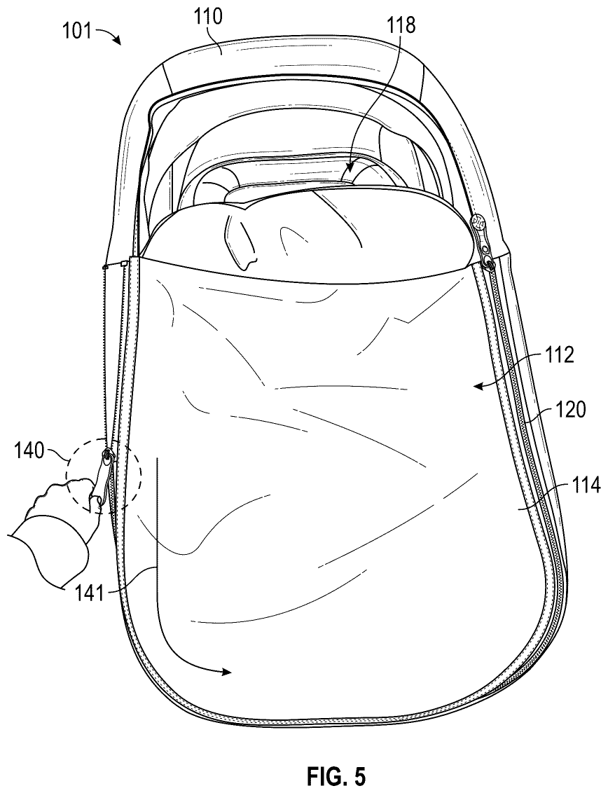

For example, as shown in FIG. 4, the storage pocket 122 is a slip pocket constructed from a stretchable mesh material. The storage pocket 122 is positioned at the rear end of the body 106 and carrier 103. In one embodiment, the storage pocket 122 is 5.5″ tall and 11″ wide. The width of the storage pocket 122 is sufficiently wide as to allow the canopy 124 and/or one or more removable attachments 112 to be placed into the storage pocket 122.

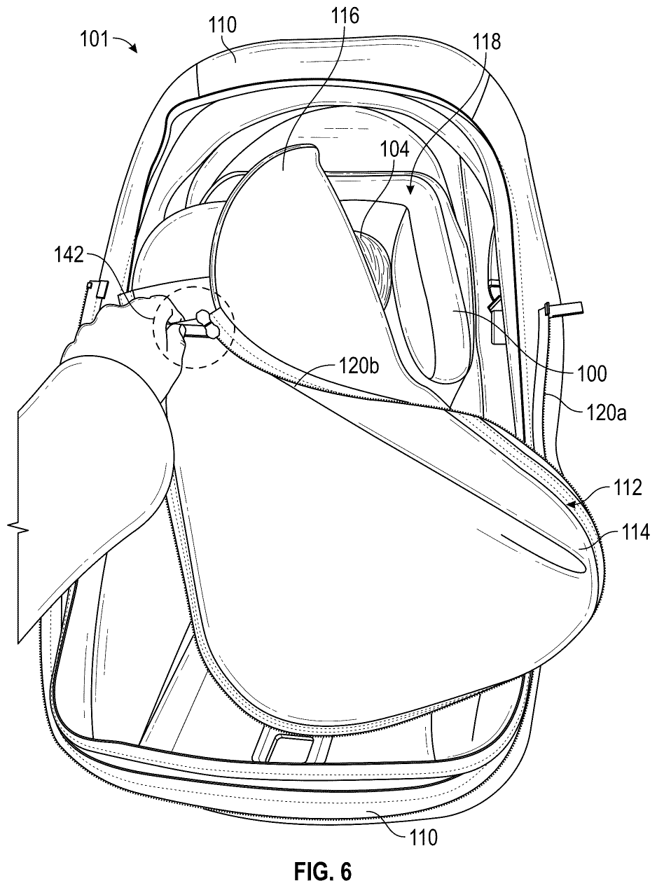

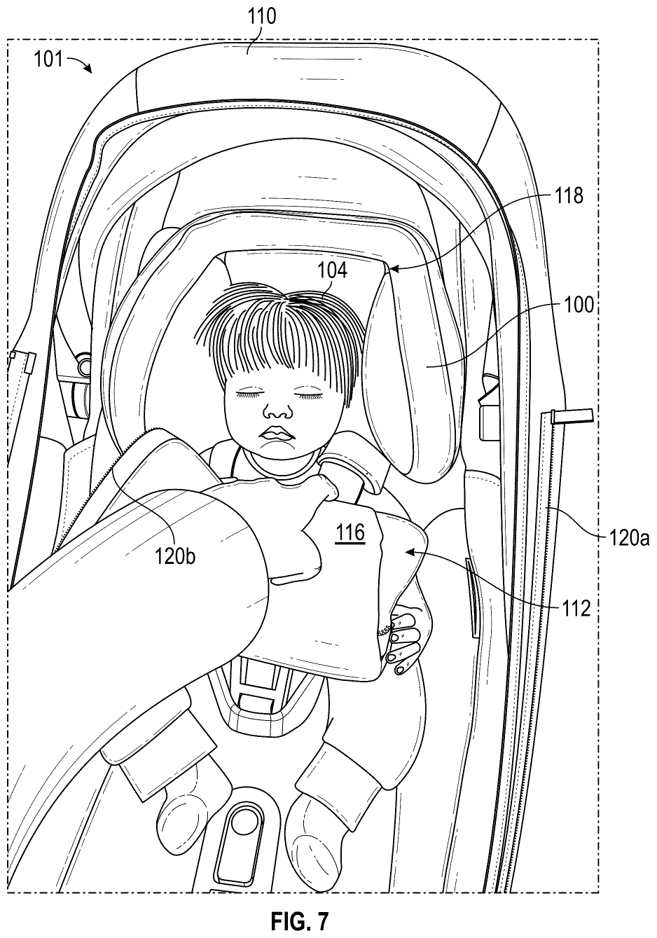

FIGS. 5-9 are various views of the removable attachment 112 of the cover 101. The attachment 112 may be a blanket, sunshade, rain cover, mesh cover, clear cover, and/or any other material covering all or some of the top opening 118 of the cover 101. In the illustrated embodiment, the attachment 112 is a blanket measuring 13″ wide and 16″ long, which is not as long as the top opening 118. The attachment 112 may have an exterior surface 114 and an interior surface 116. For example, as shown in the figures, the exterior surface 114 is a nylon material and the interior surface 116 is a fleece material. In some embodiments, the attachment 112 is reversible such that either surface of the attachment 112 may be an exterior surface 114 or an interior surface 116. For example, the attachment 112 shown in the figures may have an exterior surface 114 and an interior surface 116 that both include a fleece material.

The attachment 112 may include one or more fasteners 120 (e.g., zippers or buttons) to removably secure the attachment 112 to the body 106 of the cover 101 over the infant 104. The one or more fasteners 120 of the attachment 112 may be affixed to a corresponding one or more fasteners on the body 106, such as on the top securing edge 110. The one or more fasteners 120 may extend around some or all of the circumference of the attachment 112. For example, the fastener 120b shown in FIGS. 4-5 is a zipper that extends from the right side of the attachment 112 across a front side of the attachment 112 and the left side of the attachment 112, but not the rear side of the attachment. When the attachment 112 (e.g., blanket) is affixed to the top securing edge 110 (e.g., via the fastener 120a around part of the top opening 118), the front half of the cover 101 covers the infant 104 (e.g., below the head of the infant 104), leaving space above the head for the infant 104 to see outside the top opening 118.

To remove the attachment 112 from the cover 101, the one or more fasteners 120b of the attachment 112 may be unfastened. For example, the slider of the zipper (fastener 120) may be moved from a first position 140 on the attachment 112 in a direction 141 along the circumference of the attachment 112, as shown in FIG. 4, to a second position 142 on the attachment 112, as shown in FIG. 5. To affix the attachment 112 to the cover 101, the one or more fasteners 120b of the attachment 112 may be fastened. For example, the zipper of the attachment 112 (fastener 120b) may be placed in communication with a zipper of the top securing edge 110 (fastener 120a) and the slider of the zipper may be moved from the second position 142, as shown in FIG. 5, to the first position 140, as shown in FIG. 4.

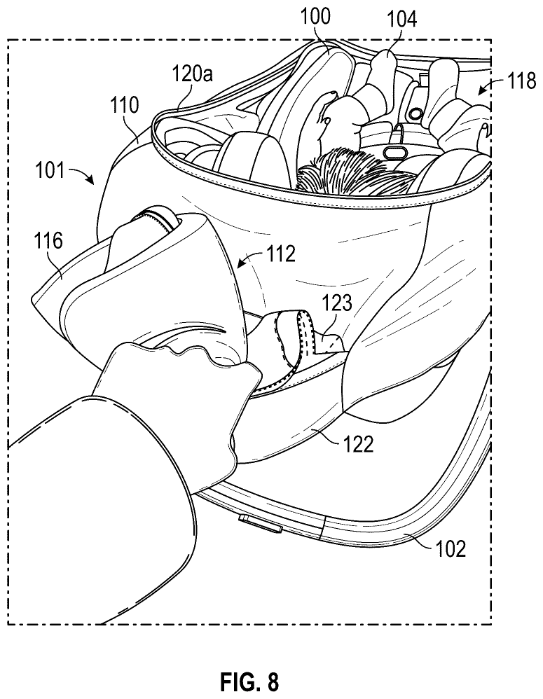

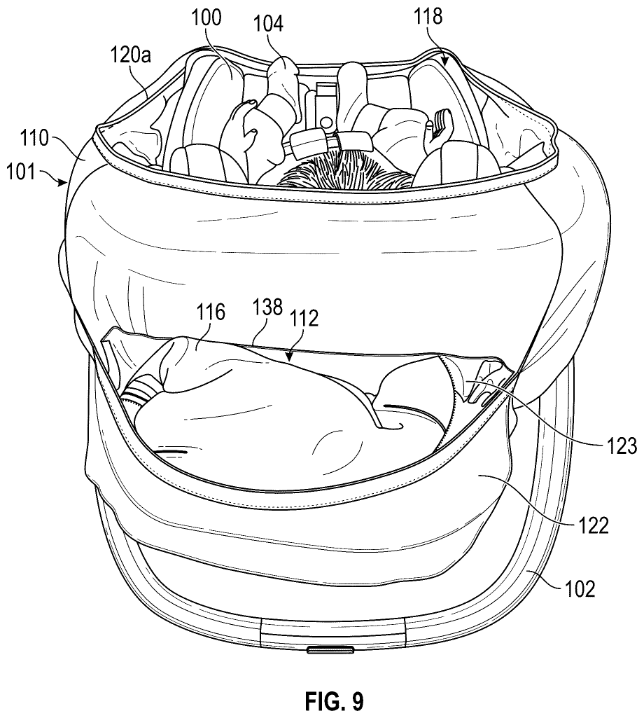

Once removed, the attachment 112 may be compacted (e.g., folded, as shown in FIG. 7) and stored, replaced with another attachment, and/or provided to the infant 104 for use. Without the attachment 112, access to the top of the carrier 103 may be provided via the top opening 118 (e.g., to move the infant 104 out from or into the carrier 103). To avoid losing the attachment 112, the removed attachment 112 may be stored in the cover 101. The cover 101 may include a storage pocket 122 built into an end of the cover 101 and carrier 103. The pocket 122 may be opened by pulling (e.g., stretching) the opening 123 away from the body 106 of the cover 101 and placing the attachment 112 into the pocket 122, as shown in FIG. 8. In some embodiments, if the attachment 112 and the canopy 124 are not in use, the attachment 112 and/or the canopy 124 may be stored in the pocket 122, as shown in FIG. 9.

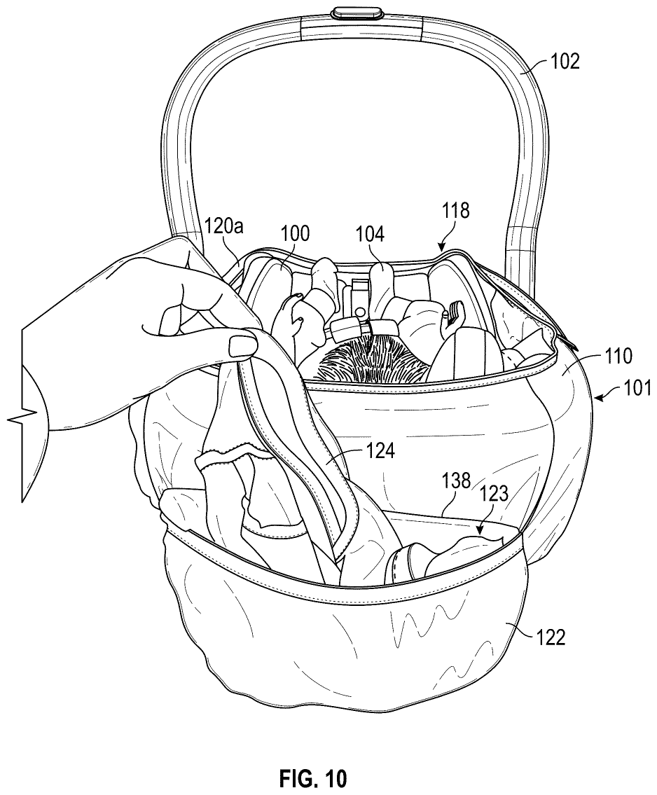

FIGS. 10-12 are various views of applying the canopy 124 of the cover 101 to the carrier 103. The canopy 124 may be configured to drape over an arm (e.g., handle 102) of the carrier 103 and cover at least the top opening 118 of the cover 101. The canopy 124 may include a rear securing edge 138 and a front securing edge 128 for securing the canopy 124 to the body 106 of the cover 101.

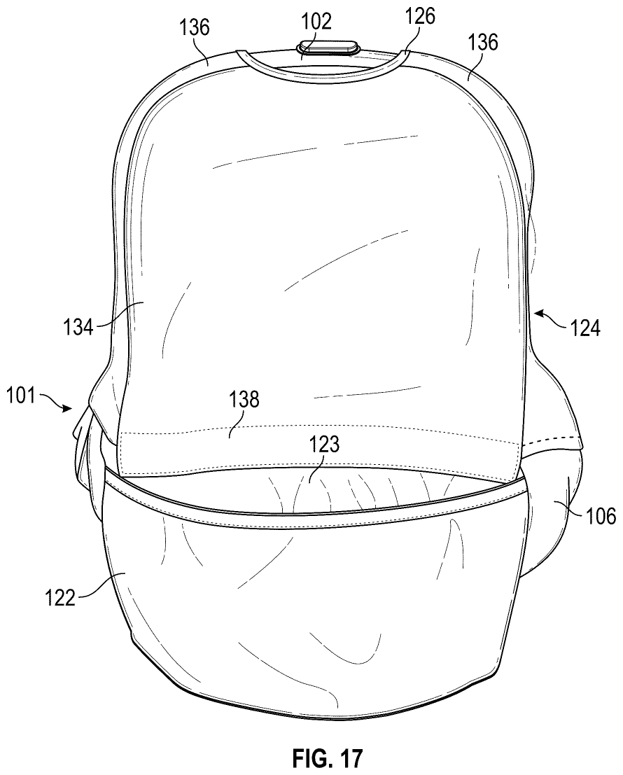

The rear securing edge 138 of the canopy 124 may be affixed to a rear end of the body 106 (as shown in FIGS. 9, 17, and 19). The rear securing edge 138 may be a portion of the edge (e.g., circumference) of the canopy 124 that is sewn, glued, bonded, or otherwise affixed to the body 106. The rear securing edge 138 of the canopy 124 may be positioned above the opening 123 of the storage pocket 122. The rear securing edge 138 may anchor a rear end of the canopy 124 as another end of the canopy 124 is being draped over the carrier 103. This way, draping the canopy 124 over the carrier 103 may be performed with one hand since a second hand does not need to be used to hold the rear end in place.

In some embodiments, the rear securing edge 138 may be a portion of the canopy 124 that is removably affixed to the body 106 by one or more fasteners (e.g., buttons or hook and loop).

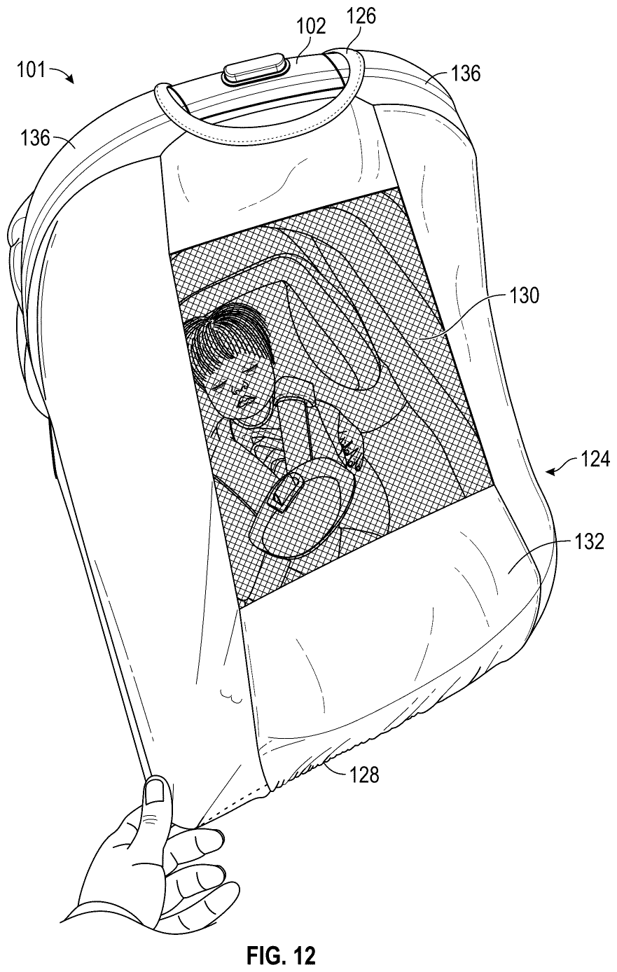

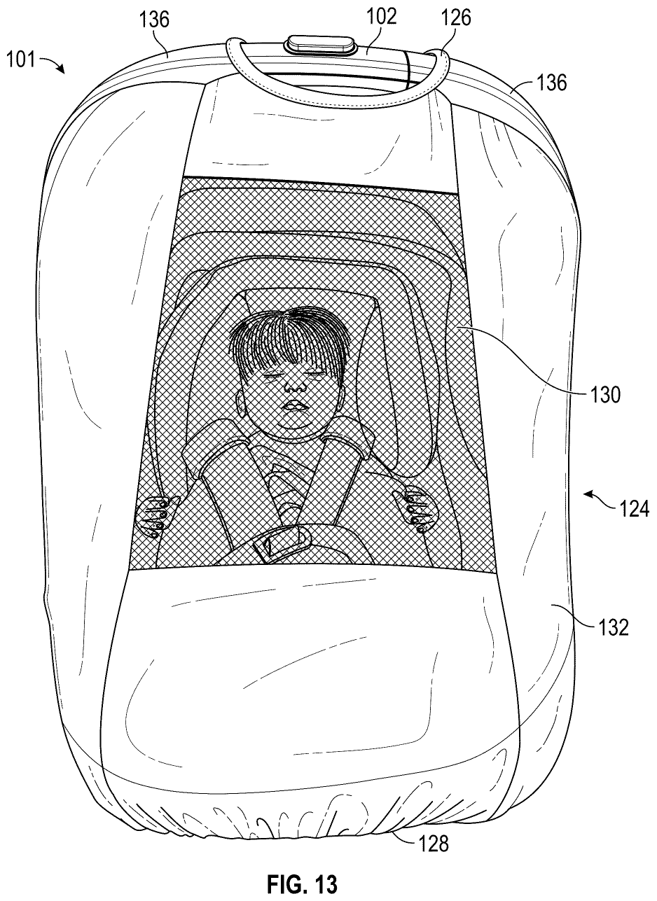

The canopy 124 may also include a front securing edge 128 removably affixed to a front end of the body 106 (as shown in FIGS. 12 and 13). The front securing edge 128 may be a portion of the edge (e.g., circumference) of the canopy 124 that is removably affixed to the body 106 by one or more elastic channels (e.g., spandex or rubber), which may be encased within a hem or tunnel of fabric of the canopy 124. Alternatively, the canopy 124 may be constructed primarily of an elastomeric material. When the canopy 124 is installed on the carrier 103, the front securing edge 128 may be stretched over an outer rim of the carrier 103. Upon release, the front securing edge 128 may create tension that causes the canopy 124 fabric to conform tightly to the shape of the carrier 103. The front securing edge 128 avoids localized stress points and minimizes the risk of the canopy 124 slipping off the carrier 103. Additionally, the front securing edge allows for ease of installation and removal, enabling users to quickly attach or detach the canopy 124 as needed without requiring additional fasteners or tools. Furthermore, the flexibility of the elastic front securing edge 128 accommodates variations in carrier dimensions, making the canopy 124 compatible with multiple models or designs of carriers.

In some embodiments, the front securing edge 128 may be a portion of the canopy 124 that is removably affixed to the body 106 by one or more fasteners (e.g., buttons or hook and loop).

In some embodiments, the front securing edge 128 may be a portion of the canopy 124 that is sewn, glued, bonded, or otherwise affixed to the body 106 to hold the front securing edge 128 to the body 106.

The front securing edge 128 and the rear securing edge 138 may be opposite sides of the canopy 124 and the cover 101, such as the front and rear ends. In some embodiments, the front securing edge 128 and the rear securing edge 138 may be any other opposing ends such as the left and right sides of the canopy 124 and the cover 101. In some embodiments, the front securing edge 128 may be the edge of the canopy 124 that is not the rear securing edge 138. For example, the canopy 124 may have an elastic edge on the parts of its edge that is not affixed (e.g., sewn) onto the body 106, which may help eliminate possible gaps between the canopy 124 and body 106 so that the space defined by the canopy 124 and carrier 103 is fully secured.

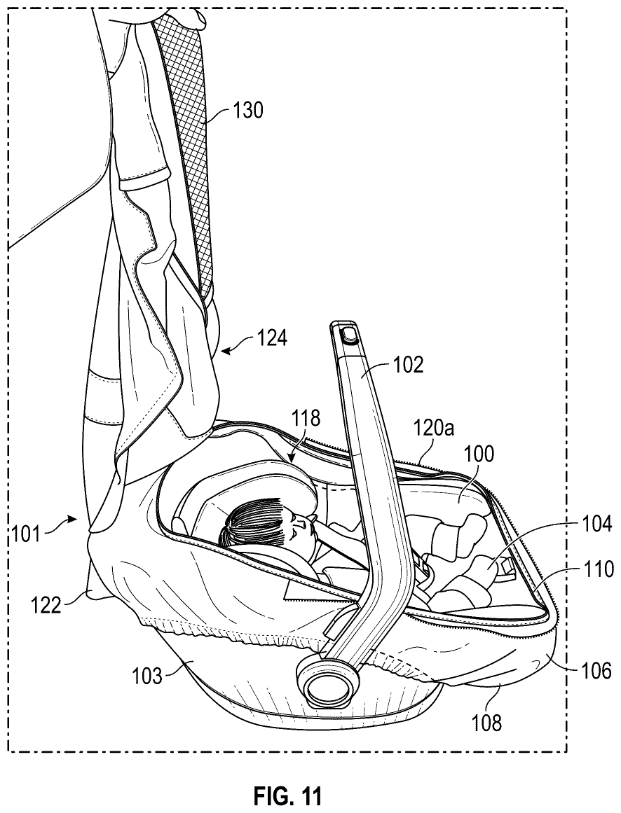

The canopy 124 may be configured to drape over the handle 102 (e.g., arm) of the carrier 103, forming a taut, tent-like structure that provides coverage and protection for the infant 104. The tent configuration leverages the structural position of the handle 102, which, when locked in an upright position, may serve as a central support for the canopy 124. To demonstrate installation of the canopy 124, FIG. 10 shows the canopy 124 being removed from the storage pocket 122, FIG. 11 shows the canopy 124 being draped over the handle 102 of the carrier 103, and FIG. 12 shows the canopy 124 fully installed in a tent-like structure.

The front securing edge 128 and rear securing edge 138 may anchor the canopy 124 to the carrier 103, creating tension along the fabric of the canopy 124 when the handle 102 of the carrier 103 is in the upright position. The upward force of the handle 102 combined with the front securing edge 128 and rear securing edge 138 pulls the canopy 124 taut, preventing sagging and maintaining a stable, tent-like structure. The design helps the canopy 124 remain securely in place even when the carrier 103 is moved, providing consistent coverage during transport. This ease of use makes the canopy 124 an effective protective barrier against sunlight, wind, and/or precipitation, while also creating a comfortable and secure space for the infant 104.

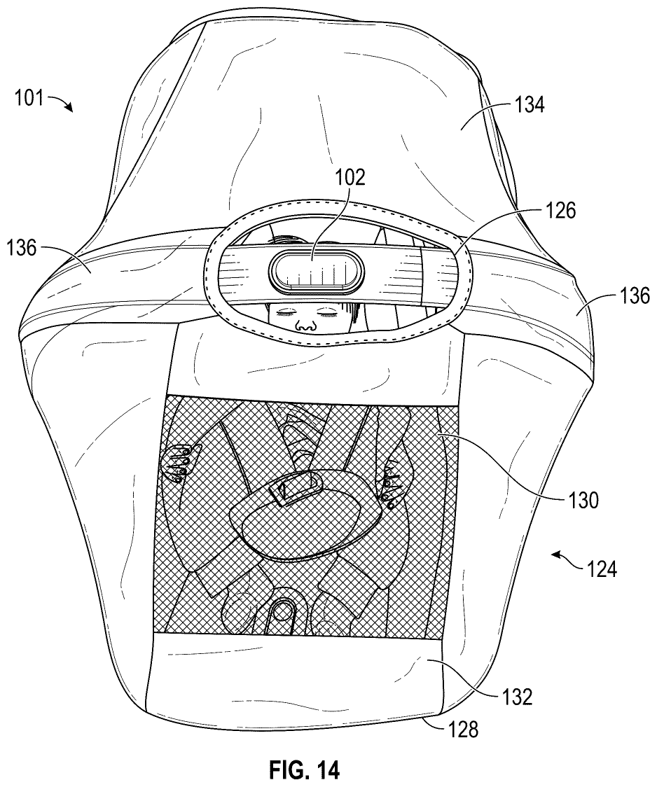

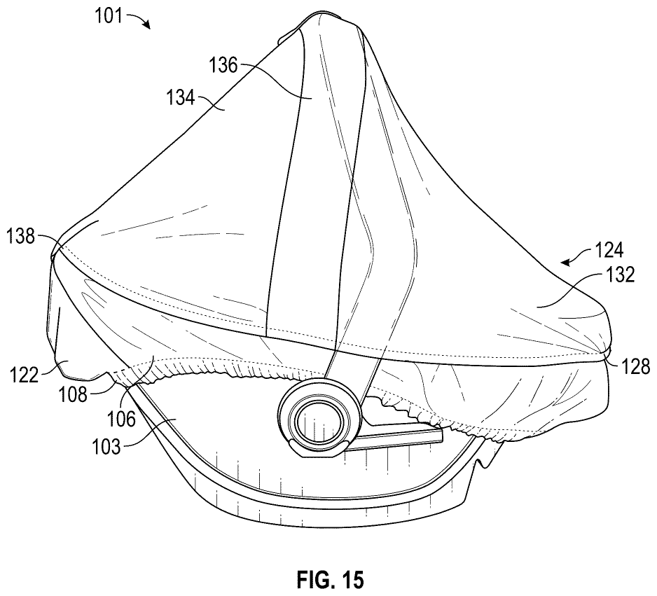

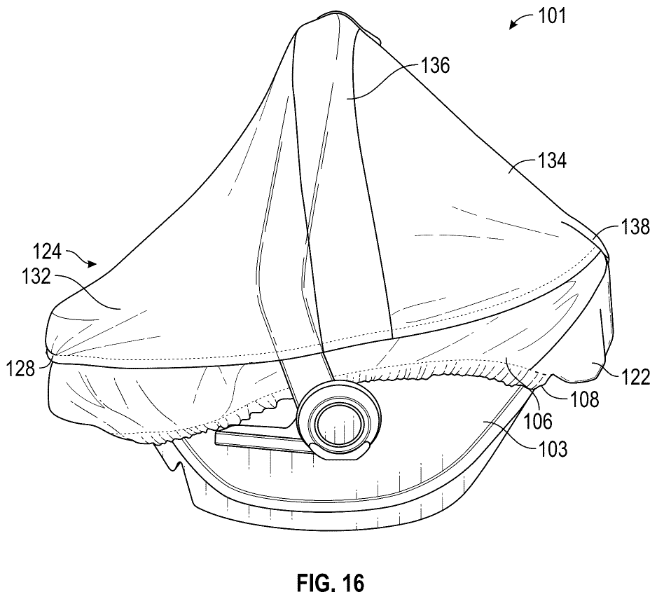

FIGS. 13-17 are various views of the canopy 124 of the cover 101 installed on the carrier 103. The canopy 124 fabric may be constructed from lightweight, durable materials, such as ripstop nylon, polyester, and/or spandex, which may be treated for ultraviolet (UV) light resistance, water repellency, and/or wind resistance. At least part of the canopy 124 may include mesh materials for ventilation and/or visibility, clear or tinted vinyl for visibility and/or rain protection, breathable membranes for waterproofing that allows moisture to escape from the carrier 103, perforated fabrics for ventilation and/or visibility, and/or any other material. In some embodiments, the cover 101 may include multiple canopies, which may be stored in the pocket 122. For example, the cover 101 may include the canopy 124 and another canopy made from a waterproof material to layer over the canopy 124.

The canopy 124 may include three panels, including a central panel 136, a front panel 132, and a rear panel 134. Each panel of the canopy 124 may each be made from the same or different material as each other panel. Each panel may include one or more sub-panels (e.g., sub-panel 130) made from a different material than its corresponding panel. For example, in some embodiments, the front panel 132 is made of an opaque material that blocks sunlight and includes a sub-panel 130 that is made from a mesh material to provide visibility into the carrier 103. In some embodiments, the canopy 124 may include greater or fewer than three panels.

The central panel 136 may span length of the handle 102. The central panel 136 may be a single piece of material and include a handle opening 126 (e.g., approximately 7″ wide) providing access to (e.g., exposing) the handle 102 of the carrier 103 so that the carrier 103 may be transported while the canopy 124 is installed. The front panel 132 and rear panel 134 may extend downwards (e.g., from the central panel 136) to cover the infant 104 and the sides of the carrier 103. The front panel 132 may be approximately 17.5″ long and 10″ wide, and the rear panel 134 may be approximately 14″ long and 10″ wide. The front panel 132 and/or rear panel 134 may include a mesh or transparent sub-panel 130 to provide visibility to the infant 104 when the canopy 124 is installed. The mesh or transparent sub-panel 130 may be approximately 10.5″ long, a side closest to the front end of the cover 101 may be approximately 9.5″ wide, and a side closest to the rear end of the cover 101 may be approximately 7.5″ wide.

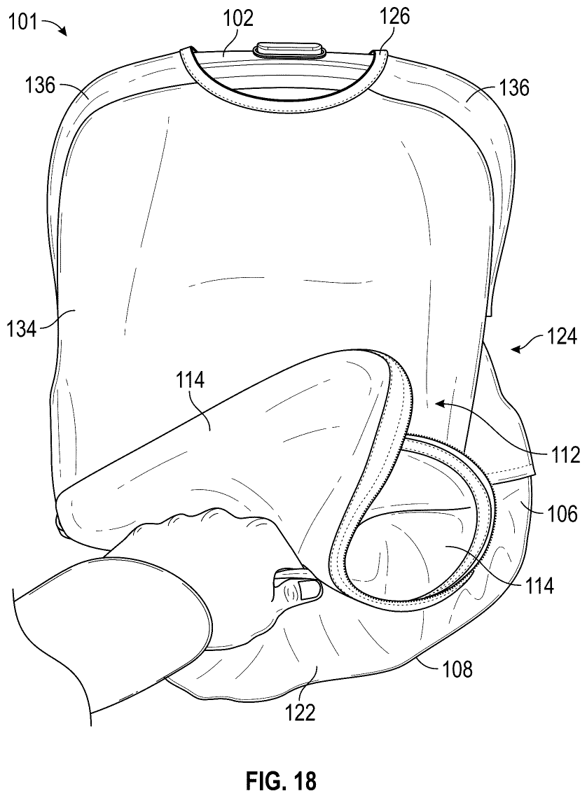

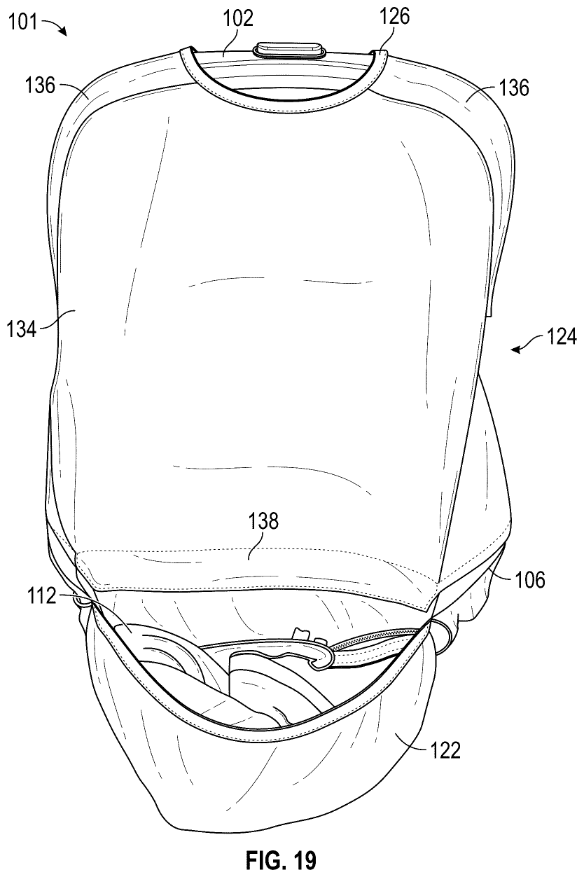

FIGS. 18-19 are various views of the attachment 112 of the cover 101 packed into the storage pocket 122 of the cover 101. The pocket 122 may be opened by pulling (e.g., stretching) the opening 123 away from the body 106 of the cover 101 and placing the attachment 112 into the pocket 122, as shown in FIG. 18.

In summary, the cover 101 may enhance the protective and environmental capabilities of an infant carrier 103 in a compact design that does not require additional rigid components. The design of the cover 101 may include an adaptable construction, utilizing elastic edges, drawstrings, and/or other tensioning mechanisms to removably secure the cover 101 and/or canopy 124 to the contours of carriers of various shapes and sizes. This enables a stable attachment that maintains its position during use, minimizing interference with the structural integrity or safety features of the carrier 103.

The cover 101 may also provide a controlled microenvironment for the infant 104, offering weather resistance through water-repellent and/or windproof outer layers, while maintaining breathability through strategically placed openings (e.g., opening 118) and/or windows (e.g., sub-panel 130). Insulative properties may also be provided using lightweight padding or thermal layers (e.g., via the attachment 112), enabling optimal thermal regulation in cold conditions. Transparent or mesh windows (e.g., sub-panel 130) integrated into the design (e.g., canopy 124) allow for caregiver monitoring without compromising structural stability or airflow. These technical attributes make the cover 101 an adaptable and reliable enhancement to infant carriers for protecting infants in a variety of environmental conditions and carriers.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A cover for an infant carrier, the cover comprising:
a body configured to cover at least part of the infant carrier, the body comprising:
a top securing edge defining a top opening configured to receive a removable attachment, and
a bottom securing edge defining a bottom opening configured to receive the infant carrier;
the removable attachment, comprising:
a fastener configured to affix the removable attachment to at least part of the top securing edge; and
a canopy configured to extend over an arm of the infant carrier and cover the top opening, the canopy comprising:
a first securing edge affixed to a first end of the body, and
a second securing edge removably securable to a second end of the body.

2. The cover of claim 1, wherein the fastener is a first fastener, and the body further comprises a second fastener corresponding to the first fastener of the removable attachment for receiving the removable attachment.

3. The cover of claim 1, wherein the removable attachment comprises an exterior surface and an interior surface, wherein the exterior surface comprises a first material and the interior surface comprises a second material different from the first material.

4. The cover of claim 1, wherein the bottom securing edge comprises an adjustable closure configured to hold the body to the infant carrier.

5. The cover of claim 1, wherein the canopy is taut when draped over the arm.

6. The cover of claim 1, wherein the canopy further comprises an opening when draped over the arm, the opening exposing at least part of the arm.

7. The cover of claim 1, wherein the canopy further comprises a window configured to allow visibility into the infant carrier.

8. The cover of claim 1, wherein the canopy is constructed from a rear panel, a central panel, and a front panel.

9. The cover of claim 1, wherein the first end of the body is a rear end of the body and the second end of the body is a front end of the body.

10. The cover of claim 1, wherein the first end of the body is a front end of the body and the second end of the body is a rear end of the body.

11. A cover for an infant carrier, the cover comprising:
a body configured to cover at least part of the infant carrier, the body comprising:
a top securing edge defining a top opening, and
a bottom securing edge defining a bottom opening configured to receive the infant carrier; and
a canopy configured to extend over an arm of the infant carrier and cover the top opening, the canopy comprising:
a first securing edge affixed to a first end of the body, and
a second securing edge removably securable to a second end of the body opposite the first end.

12. The cover of claim 11, further comprising a removable attachment, the removable attachment comprising:
a fastener configured to affix the removable attachment to at least part of the top securing edge.

13. A cover for an infant carrier, the infant carrier comprising a carrying handle and a base having a rear edge and a front edge, the cover comprising:
a body comprising:
a storage pocket proximate a first end of the body and configured to receive any one or more of a removable attachment and a canopy,
a top securing edge defining a top opening and configured to receive the removable attachment, and
a bottom securing edge defining a bottom opening and configured to receive the infant carrier;
the removable attachment configured to be removably attached to at least part of the top securing edge; and
the canopy configured to extend over the carrying handle and cover the top opening, the canopy comprising:
a first securing edge affixed to the first end of the body, and
a second securing edge removably securable to a second end of the body.

14. The cover of claim 13, wherein the body is configured to cover at least part of the infant carrier.

15. The cover of claim 13, wherein the body further comprises a first fastener and the removable attachment comprises a second fastener corresponding to the first fastener to enable the removable attachment to be removably attached to the body.

16. The cover of claim 13, wherein the removable attachment comprises an exterior surface and an interior surface, wherein the exterior surface comprises a first material and the interior surface comprises a second material different from the first material.

17. The cover of claim 13, wherein the bottom securing edge comprises an adjustable closure configured to hold the body to the infant carrier.

18. The cover of claim 13, wherein the canopy is taut when draped over an arm of the infant carrier.

19. The cover of claim 13, wherein the canopy further comprises an opening when draped over an arm of the infant carrier, the opening exposing at least part of the arm.

20. The cover of claim 13 wherein cover is constructed from an elastomeric material.
